(19) United States
(12) Patent Application Publication
(10) Pub. No.: US 2007/0300176 A1
(43) Pub. Date: Dec. 27, 2007

(54) Entering Information in Input Field

(76) Inventors: Ilja Fischer, Heidelberg (DE); Juergen Schmerder, Wiesloch (DE); Heinz Willumeit, St. Leon-Rot (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/426,426

(22) Filed: Jun. 26, 2006

(51) Int. Cl. G06F 3/048

(52) U.S. Cl. 715/780

(57) ABSTRACT

A method of supporting a user in entering information in an input field includes receiving a string that a user enters under guidance of an input field in a graphical user interface (GUI) in a computer system, the GUI being associated with creating an instance of a first object. There is identified, among several objects in the computer system, a second object with which the first object is associated, the second object being identified using an association between the first object and the second object that is associated with the input field. The method further includes performing a query associated with the second object among instances of the second object, the query being performed using the string to determine an entry that is to be displayed in the input field and that represents information to be included in the instance upon creation.

### TECHNICAL FIELD

The description relates to entering information in an input field of a graphical user interface.

### BACKGROUND

Many computer systems provide a graphical user interface (GUI) for guiding a user in entering information into the system, and presenting information that has previously been entered in some way. Sometimes the GUI takes the shape of a form with fields for text entry, where each of the fields is dedicated for a particular kind of data or a category of information. A user will then enter the required information type in each of the fields and then trigger the system to perform a specific action using the entered information, such as to create a new object based on the information. For example, the GUI for creating a sales order allows the user to name a specific customer that the sales order should refer to.

It can, however, be difficult for users to know exactly what information to enter in a specific field, particularly if there are many different fields in the GUI, or if the particular field requires information of a complex nature. For this reason, help features have been provided. One of these is referred to as “Value Help” in products from SAP AG, and allows the user to open a popup window for each field and therein view a list of (or search for) the possible entry values for the field. The popup window displays the correct set of entry values because the GUI input field is mapped to the corresponding field in the underlying object.

### SUMMARY

The invention relates to supporting a user in entering information in an input field. In general, an input field of a GUI is shown to accept entries that are either the information type that the field is configured to accept or another string formulated by the user. If the latter is received, the input field triggers a search to determine the information having the right type. The information is determined using a query that is obtained due to the input field having previously been associated with a preexisting association between objects.

In a first general aspect, a method of supporting a user in entering information in an input field includes receiving a string that a user enters under guidance of an input field in a graphical user interface (GUI) in a computer system, the GUI being associated with information entry for an instance of a first object. There is identified, among several objects in the computer system, a second object with which the first object is associated, the second object being identified using an association between the first object and the second object that is associated with the input field. The method further includes performing a query associated with the second object among instances of the second object, the query being performed using the string to determine an entry that is to be displayed in the input field and that represents information to be included in the instance.

Implementations may include any or all of the following features. The query may produce one result, and the method may further include using the one result in determining the entry and displaying the entry in the input field. The query may produce several results, and the method may further include (1) displaying the several results to the user and receiving a user selection of one of the results, and (2) using the selected result in determining the entry and displaying the entry in the input field. The information to be included in the instance may be an identifier for one of the instances of the second object and the entry may further comprise business information associated with the identifier. The business information may be a non-technical representation of the instance of the second object. The method may further include obtaining the business information from the instance of the second object. The method may further include displaying the entry in the input field as a hyperlink to one of the instances of the second object. The computer system may include a portal configured to provide navigation to an object upon receiving an object type and an object identifier, and the method may further include forwarding to the portal, upon user selection of the hyperlink, a type of the instance of the second object and an identifier of the instance of the second object. The instance of the first object may not exist before the string is entered, and the string may be entered as part of creating the instance of the first object. The instance of the first object may exist before the string is entered, and the string may be entered as part of modifying the existing instance of the first object.

In a second general aspect, a computer program product is tangibly embodied in an information carrier and includes instructions that, when executed, generate on a display device a graphical user interface supporting a user in entering information in an input field. The graphical user interface includes an input field configured to have displayed therein (1) a string entered by a user for an instance of a first object, and subsequently (2) an entry that represents information to be included in the instance, the input field having associated therewith an association between the first object and a second object. Determining the entry includes performing a query associated with the second object using the string.

Implementations may include any or all of the following features. The instance of the first object may not exist before the string is entered, and the string may be entered as part of creating the instance of the first object. The instance of the first object may exist before the string is entered, and the string may be entered as part of modifying the existing instance of the first object. The query may produce several results and the graphical user interface may be configured to display the several results to the user and receive a user selection of one of the results, and the entry may be determined using the selected result and displayed in the input field. The entry may be displayed in the input field as a hyperlink to one of the instances of the second object. A portal may be configured to provide navigation to an object upon receiving an object type and an object identifier, and the graphical user interface may be configured to forward to the portal, upon user selection of the hyperlink, a type of the instance of the second object and an identifier of the instance of the second object.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A shows a sales order quote creation GUI containing a tokenizer control;

FIG. 1B shows a customer name entered in the tokenizer control;

FIG. 1C shows an entry value displayed in the tokenizer control;

FIG. 2 is a diagram illustrating the relationships of objects and instances;

FIG. 3 is a block diagram of a computer system that provides navigation from content to a portal page;

FIG. 4 is a flow diagram detailing the creation of a sales order using the tokenizer;

FIG. 5 is a screen shot of a pop-up window for returning multiple results to a sales order quote creation GUI;

FIG. 6 is a flow chart of an exemplary method; and

FIG. 7 is a block diagram of a general computer system.

Like reference numerals in the various drawings indicate like elements.

### DETAILED DESCRIPTION

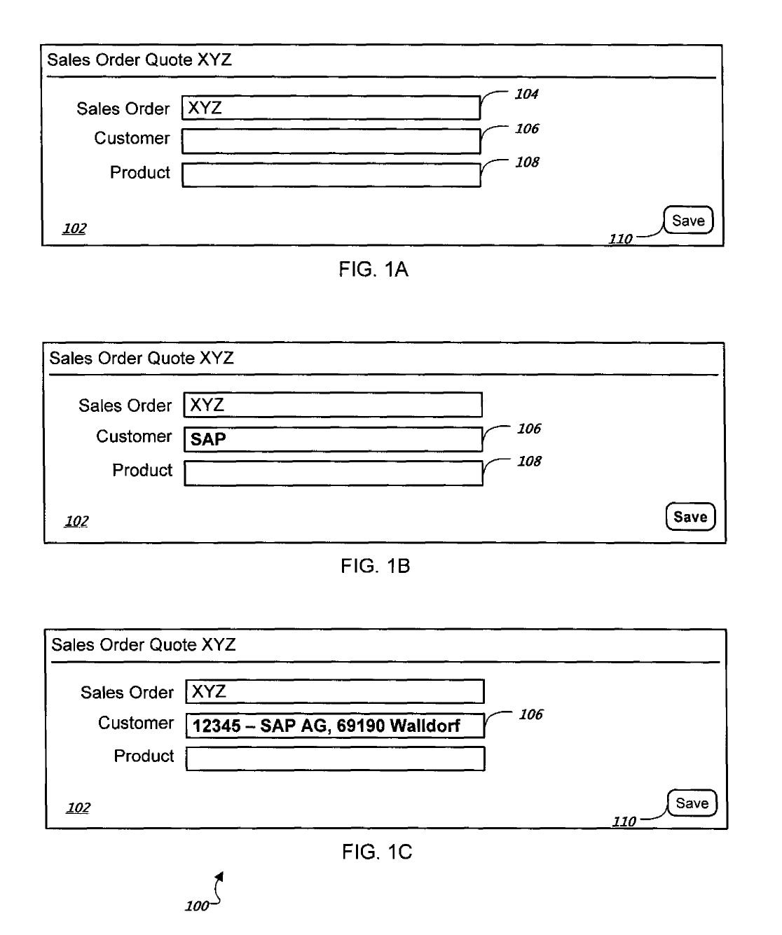

FIGS. 1A-1C contain screen shots 100 of a graphical user interface (GUI) 102 that can be used to generate or modify a sales order quote. In FIG. 1A, a user has initiated the GUI 102 to create a new sales order quote, for example relating to a certain customer that is purchasing one or more products. A name input box 104 allows the user to input a name that uniquely identifies the particular sales order. Rather than a user entry, the sales order name may be an auto-generated identification number or alpha-numerical code. A customer tokenizer box 106 acts as an input box when the user types in the exact information needed, such as the customer identifier key. The customer tokenizer box 106 may also be used as a search tool by inputting a phrase describing the information needed, such as providing a customer name, and a customer identification key may then automatically be identified using the phrase. The customer tokenizer box 106 is used to either submit a known customer key or to input a descriptive term or phrase to be used to query fields of the customer record to locate a unique customer key. Particularly, associations between objects will be used to identify a customer match to the search phrase.

A product input box 108 allows the user to associate a particular product with the sales order quote. The product input box 108 may be an additional tokenizer for inputting or finding a product identification key, or it may be a standard input control. A save button 110 is used to create the new sales order quote once the customer key and/or product key have been submitted or obtained.

In FIG. 1B, the user inputs the string SAP into the customer tokenizer box 106. First, the tokenizer determines whether or not the entry is a valid customer identification key. If it is, that key will be accepted as the entry for the customer field. If not, the tokenizer will attempt to locate an existing customer record which matches the phrase inputted, in this case “SAP”. The tokenizer will return all matching identification keys of customer records containing the term “SAP”. The phrase used for a customer key look-up does not necessarily have to be customer name. It could relate to another field in the customer record, e.g. address. Rather than a single term, a phrase containing multiple words relating to one or more fields of the customer record may be typed into the customer tokenizer box 106, i.e. “SAP India” which refers to both the customer name and the location of the customer.

In this example, a single customer matches the string that the user enters in the customer tokenizer box 106. In FIG. 1C, a return value is displayed in the customer tokenizer box 106. Based on the input term “SAP” found in the customer tokenizer box 106 of FIG. 1B, the tokenizer has returned a customer key 12345 for a company named SAP AG, whose address includes the terms “69190 Walldorf”. The information following the customer key allows the user to verify that this is the customer the user had in mind. The ”12345” record was identified by running a query, identified using an association between an object for the sales order quote and an object for the customer, for any customer that matches “SAP”. Alternatively, if there are no matches to a query, the user may be alerted within the customer tokenizer box 106 that no match is found. If the result was not what the user had anticipated, e.g. the user mistyped the spelling of the customer name and was returned the incorrect customer key, the user may again type an entry in the customer tokenizer box 106 to find the desired customer key. If there is more than one match to a query, a pop-up window may be presented to allow the user to select which customer he or she desires. Similarly, the user may use the product input box 108 to enter a specific product before creating the new sales order quote.

This method may be used, in another implementation, to modify or otherwise access an existing sales order quote. For example, the user may wish to make a change to the sales order XYZ and may therefore search for it using the GUI 102. When the user activates the button 110 (which may then have a different appearance), the existing sales order could be presented, e.g. within a pop-up window or other GUI implementation. The user may then be able to modify fields of the sales order. For example, the user may wish to add or remove products listed within the sales order quote.

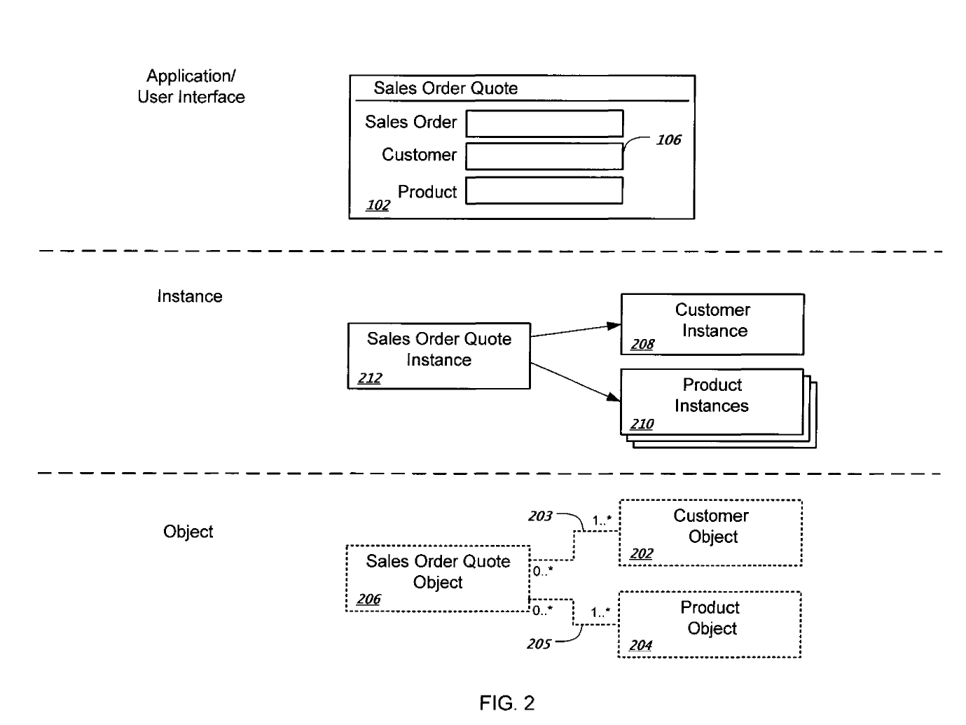

FIG. 2 conceptually illustrates business objects and instances that are accessed by the GUI 102 through the customer tokenizer box 106. A business object is a basic template for a grouping of stored information. For example, a customer business object 202 may be composed of many fields, e.g. name, address, phone number, date of first purchase, billing information, etc. Similarly, a product business object 204 may be composed of fields including name, model number, materials type, price, dimensions, weight, etc. A business object may be associated with another business object, i.e. a customer object may have a financing agreement object connected to it. A business object contains a key field such that each instance of the business object can be uniquely identified.

A customer object and a product object are required to define a sales order quote object 206. One sales order object can be assigned to one or more customers; one customer can be assigned to any number of sales orders; one product can be assigned to any number of sales orders. Particularly, the sales order quote object is here defined as having an association 203 with the customer object 202. Also, the sales order quote object is defined as having an association 205 with the product object 204. For example, the customer key and the product key are fields within the sales order business object which create the association between the business objects. There may be any number of business objects related to the sales order quote object 206.

An instance is a unique instantiation of a business object created by populating the fields of the business object with information that is particular to an entity to be represented by the instance. A customer instance 208 may contain the name, address, phone number, etc of a specific customer. Similarly, each of several product instances 210 may contain the name, model number, price, etc. of a specific product. There can be many instances of each business object. Each instance is uniquely identified by a key. For example, a sales order quote instance 212 contains the key of the customer instance 208 and any number of key(s) of the product instance(s) 210.

To create the sales order quote instance 212 using the GUI 102, the customer tokenizer box 106 allows the user to submit either a customer key or a string which may be used to locate a customer key. The customer tokenizer box 106 uses associations to relate the user input to the customer object 202. A query is then defined to retrieve the customer key(s) of any customer instances which contain the information within the search string. In addition to the customer instance 208 and the product instance(s) 210, there may be additional instances linked to a sales order quote, such as a financing information instance, etc. Rather than a sales order quote, a similar GUI 102 could be used to create, for example, a repair order or a customer support request.

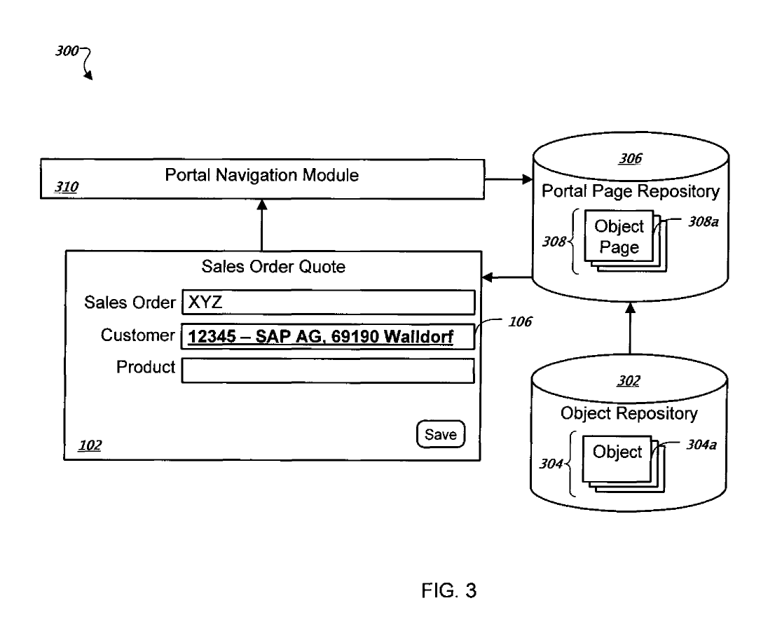

FIG. 3 shows a computer system 300 that provides navigation from content to a portal page within a portal. An object repository 302 stores objects 304 and, in particular, a first object 304a. The objects 304 are to be used in generating instances of products, sales documents, business representatives, trading partners, customers, vendors and other entities with which a business relationship exists or could be established. A portal page repository 306 stores portal pages 308 that relate to specific object instances. The customer tokenizer box 106 within the GUI 102 is configured to present a link to any or all of the portal pages 308. A user can activate the link to display a first object page 308a, which presents information about the first object 304a. This allows the user to verify that the selected entry in the tokenizer box 106 is the correct one. The repositories 302 and 306 may be separate (as shown) or combined. In some systems, either or both of the repositories are implemented using an Enterprise Service Repository (ESR) that is available in products from SAP AG in Walldorf (Baden), Germany.

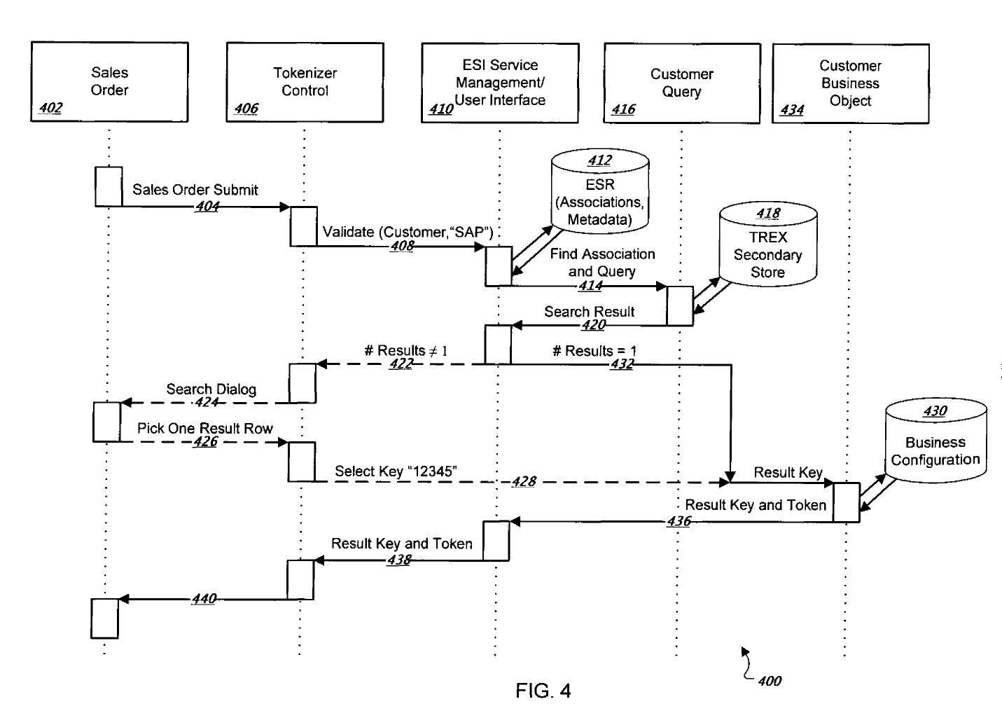

When the user activates the link, the object key or keys belonging to the matching object(s) is forwarded to a portal navigation module 310. In some implementations, a type of the sought business object (here a customer object) is also forwarded to the portal navigation module. When the portal navigation module 310 receives the object key(s), it causes the associated object page(s), such as the first object page 308a, to be displayed within the GUI 102. In FIG. 4, an exemplary flow diagram 400 conceptually illustrates the creation of a sales order within a software system using a tokenizer. A user begins the process of creating a new sales order by initiating a sales order interface 402 within the software system. The user enters the term “SAP” into the interface 402, which triggers a submission 404 to a customer tokenizer control 406. First, the tokenizer control 406 validates whether or not the entry is a customer key (step 408). In this example, “SAP” is not a customer identification key, so the string is passed to an Enterprise Services Infrastructure (ESI) service management/user interface 410 to find an association between the sales order object and the customer object. This association will help build a query to locate matching customer instances to the phrase “SAP”.

An Enterprise Services Repository (ESR) 412 contains associations and other metadata. These associations are used by the ESI service management/user interface 410 to verify which object the current (sales order) object is related to. Particularly, the association that will be selected is the one that the tokenizer control 406 is associated with. The associated metadata within the ESR 412 is then used to define a customer query 416 to locate the dependent object's identifier key (i.e. customer ID) that the independent object (i.e. sales order) should contain (step 414).

The customer query 416 is here performed in a secondary store 418 which includes the TREX repository and search engine available from SAP AG in Walldorf (Baden), Germany. The secondary store 418 contains multiple instances of business objects. A query is run against the contents of the secondary store 418 to locate the customer instances which match the string “SAP”. For example, one or more customer instance may be discovered in which “SAP” matches all or a portion of the name field. In another example, a search phrase may match different field types of different customer instances, i.e. the string “waverly” may match both the name “John Waverly” of one customer instance and the address “Waverly Lane” of another customer instance. In yet another example, a phrase composed of multiple terms may be submitted to the tokenizer control 406. The ESR 412 and secondary store 418, though visualized as separate storage entities in the diagram, may be located in the same repository in some implementations. Search results, in the form of the key field(s) of one or more customer instances, are returned to the ESI service management/user interface 410 (step 420).

If there are either no results or multiple results, the information in this example is propagated back to the sales order interface 402 through the tokenizer control 406 (step 422) to be presented to the user, because the tokenizer control 406 here accepts only a single customer. If there were no results, the user will be presented with a failure notification and prompted to enter a different string. In the case of multiple results, a search dialog is opened to allow the user to select a single result (step 424). The search dialog, for example, may be in the form of a pop-up window. All keys matching the query are listed within the search dialog. In other implementations, business information may be listed within the search dialog.

The user selects a row from the list of customer keys (step 426). The selection is sent through the tokenizer control 406 to a business configuration repository 430 (step 428). In the case of the query generating a single result (step 432), the result is instead forwarded directly to the business configuration repository 430.

The business configuration repository 430 contains information specifying which fields of the business objects are used to make up their human-readable tokens. Using the result key returned from the customer query 416, a token is generated to be viewed within the tokenizer control 406 of the sales order interface 402. The token contains information retrieved from the customer instance associated with the result key relating to one or more fields of a customer business object 434, e.g. for business object customer, the token may be a concatenation of customer id, customer name, customer address city, and customer address zip code. This information helps the user to verify that the correct customer key has been obtained. The result key and token are propagated back through the ESI service management/user interface 410 (step 436) and then via the tokenizer control 406 (step 438) to the sales order interface 402 (step 440). The sales order interface 402 will present the token to the user.

Not all of the steps within the sales order system 400 must be taken in this order. In addition, some steps may be combined. In another implementation, if more than one search results are found (step 422), a set of tokens may first be obtained from the business configuration repository 430 for all of the result keys, such that the user may be presented, within the search dialog (step 424), a set of descriptive tokens to aid in the selection of a final customer key.

The full process illustrated may be truncated. For example, in a multiple result scenario (step 422), the result set returned to the user (step 424) may not be the one desired (i.e. the user typed “Johnson” but had meant to type “Johnston”, so the wrong set of customer tokens was returned). The user may choose to close the search dialog and submit a new query (step 404) rather than selecting a row from the result list (step 426).

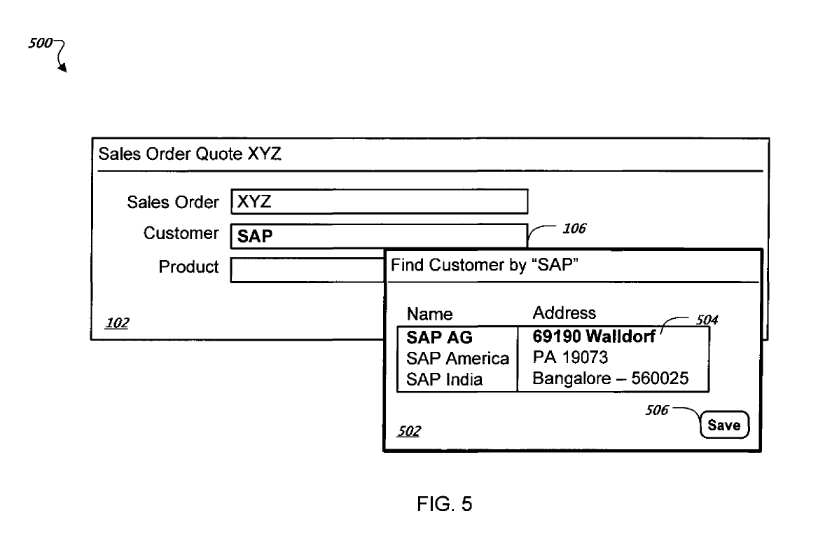

As shown in FIG. 5, a graphical user interface (GUI) screen shot 500 provides the user with multiple results from a tokenizer search. Within the GUI 102, the customer tokenizer box 106 contains the string “SAP”. A pop-up window 502 is overlaid upon the GUI 102. The pop-up window 502 contains multiple entries which match the search term “SAP”. Each matching customer is listed by both name and address. Each row is user-selectable. A first row 504 is highlighted as having been selected. The contents displayed for the first row 504 are a customer name of “SAP AG” and an address of “69190 Walldorf”. This information has been provided to help the user to determine which entry of the result list matches the customer that the user had in mind.

The user may now select a save button 506 to accept the first row 504 as the desired match. Selection of the save button 506 may, for example, close the pop-up window 502 and return the user to the GUI 102 where the customer tokenizer box 106 would contain the customer key associated with the first row 504. Alternatively, rather than containing the save button 506, each result row within the pop-up window 502 could be a selectable control used to return the user to the initial GUI 102. The user may alternatively opt to select one of the other customer entries listed.

The presentation method is not limited to a pop-up menu. In another implementation, an expanded customer tokenizer box 106 has a drop-down menu capability. Multiple entries could be returned to the user within the drop-down menu. In addition, the information presented to the user is not limited to name and address. Any number of information fields may be provided to allow the user to discriminate which is the desired entry. Alternately, a hyperlink to the full customer instance, such as the one provided within the customer tokenizer box 106 of FIG. 3, may be offered to allow the user to review a customer record in its entirety.

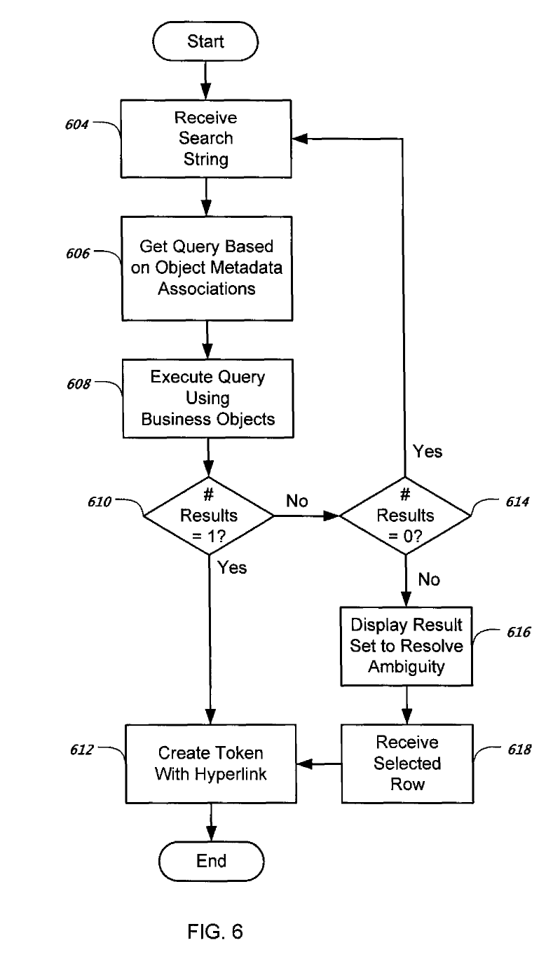

In FIG. 6, an exemplary flow diagram 600 illustrates functionality of a tokenizer query within a software system. After the start of the process, the software system receives a search string (step 604). A user may have submitted the search string into the system using a GUI, for example. The search string contains one or more terms relating to information fields in a first business object that is to be created. The tokenizer is associated with an association between the first object and a second object. Using the search string, a query is obtained based on the object metadata associations (step 606). The method executes this query against a collection of business objects to find matching information (step 608).

The method involves checking the number of results obtained from the query (step 610). If there is a single result, the method creates a token with a hyperlink (step 612). A token is related to the identification key of the matching instance of the second business object. The text of the hyperlink (e.g., the token) uniquely identifies the second business object instance for the user. It may contain a descriptive string in addition to the key to allow the user to recognize which instance the key belongs to. The hyperlink connects the user to the application (e.g., a portal page) that is used to view or maintain the complete details of the selected instance of the second business object.

If, instead, there is not just a single result, the method checks whether there are zero results (step 614). If so, the method loops back to receive a different search string (step 604). In one implementation, the user will be informed of the lack of results and prompted to enter a new search string.

If there are multiple results, the system displays the result set to the user to resolve the ambiguity (step 616). The result set, in one implementation, may be formatted within a pop-up window as illustrated in FIG. 5. The user will be provided, in some appropriate manner, a means in which to select one row from a set of query results. The process receives the selected row (step 618) and creates a token with a hyperlink based on the information associated with the selected row (step 612). Once the token and hyperlink have been created, the software module is exited.

There may be more or fewer steps than those illustrated within the flow diagram 600, and the steps do not necessarily have to be in this order. For instance, in the case of multiple results (step 614), a token and hyperlink may be created for each one (step 612) before the results are displayed to resolve ambiguity (step 616).

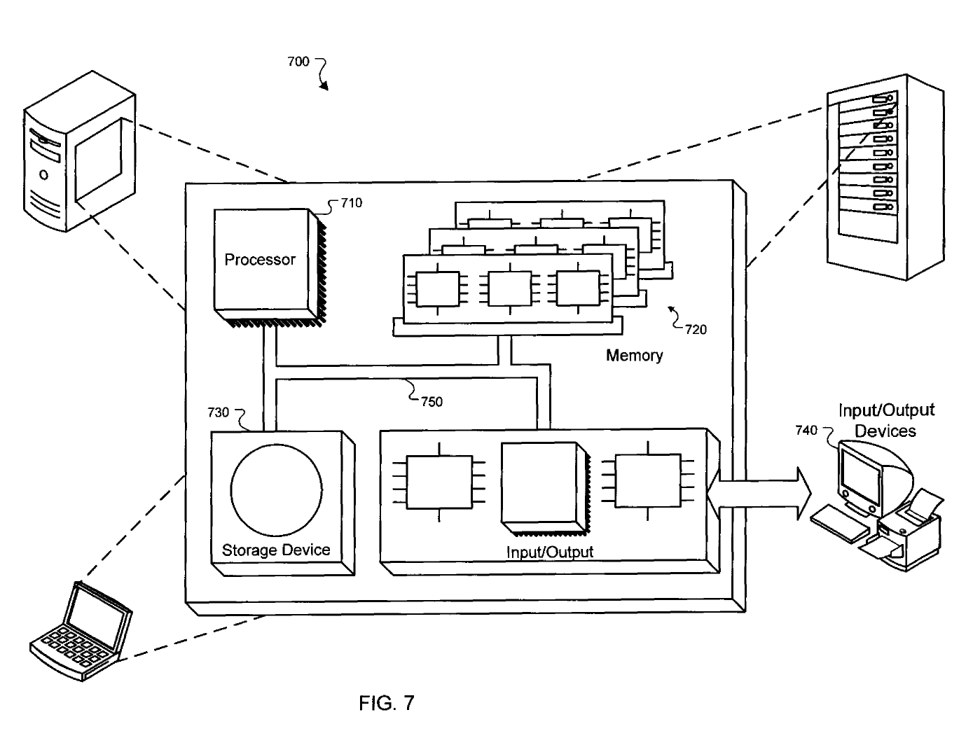

FIG. 7 is a schematic diagram of an example of a generic computer system 700. The system 700 can be used for the operations described in association with the method 400 according to one implementation.

The system 700 includes a processor 710, a memory 720, a storage device 730, and an input/output device 740. Each of the components 710, 720, 730, and 740 arc interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program canbe written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A method of supporting a user in entering information in an input field, the method comprising:
receiving a string that a user enters under guidance of an input field in a graphical user interface (GUI) in a computer system, the GUI being associated with information entry for an instance of a first object;
identifying, among several objects in the computer system, a second object with which the first object is associated, the second object being identified using an association between the first object and the second object that is associated with the input field; and
performing a query associated with the second object among instances of the second object, the query being performed using the string to determine an entry that is to be displayed in the input field and that represents information to be included in the instance of the first object.

2. The method of claim 1, wherein the query produces one result, further comprising using the one result in determining the entry and displaying the entry in the input field.

3. The method of claim 1, wherein the query produces several results, further comprising (1) displaying the several results to the user and receiving a user selection of one of the results, and (2) using the selected result in determining the entry and displaying the entry in the input field.

4. The method of claim 1, wherein the information to be included in the instance is an identifier for one of the instances of the second object and wherein the entry further comprises business information associated with the identifier.

5. The method of claim 4, wherein the business information is a non-technical representation of the instance of the second object.

6. The method of claim 4, further comprising obtaining the business information from the instance of the second object.

7. The method of claim 1, further comprising displaying the entry in the input field as a hyperlink to one of the instances of the second object.

8. The method of claim 7, wherein the computer system includes a portal configured to provide navigation to an object upon receiving an object type and an object identifier, further comprising forwarding to the portal, upon user selection of the hyperlink, a type of the instance of the second object and an identifier of the instance of the second object.

9. The method of claim 1, wherein the instance of the first object does not exist before the string is entered, and wherein the string is entered as part of creating the instance of the first object.

10. The method of claim 1, wherein the instance of the first object exists before the string is entered, and wherein the string is entered as part of modifying the existing instance of the first object.

11. A computer program product tangibly embodied in an information carrier, the computer program product including instructions that, when executed, cause a processor to perform operations supporting a user in entering information in an input field, the operations comprising:
receiving a string that a user enters under guidance of an input field in a graphical user interface (GUI) in a computer system, the GUI being associated with information entry for an instance of a first object;
identifying, among several objects in the computer system, a second object with which the first object is associated, the second object being identified using an association between the first object and the second object that is associated with the input field; and
performing a query associated with the second object among instances of the second object, the query being performed using the string to determine an entry that is to be displayed in the input field and that represents information to be included in the instance of the first object.

12. A computer program product tangibly embodied in an information carrier, the computer program product including instructions that, when executed, generate on a display device a graphical user interface supporting a user in entering information in an input field, the graphical user interface comprising:
an input field configured to have displayed therein (1) a string entered by a user for an instance of a first object, and subsequently (2) an entry that represents information to be included in the instance, the input field having associated therewith an association between the first object and a second object, wherein determining the entry includes performing a query associated with the second object using the string.

13. The computer program product of claim 12, wherein the instance of the first object does not exist before the string is entered, and wherein the string is entered as part of creating the instance of the first object.

14. The computer program product of claim 12, wherein the instance of the first object exists before the string is entered, and wherein the string is entered as part of modifying the existing instance of the first object.

15. The computer program product of claim 12, wherein the query produces several results and wherein the graphical user interface is configured to display the several results to the user and receive a user selection of one of the results, wherein the entry is determined using the selected result and displayed in the input field.

16. The computer program product of claim 12, wherein the entry is displayed in the input field as a hyperlink to one of the instances of the second object.

17. The computer program product of claim 16, wherein a portal is configured to provide navigation to an object upon receiving an object type and an object identifier, and wherein the graphical user interface is configured to forward to the portal, upon user selection of the hyperlink, a type of the instance of the second object and an identifier of the instance of the second object.
